(19) United States
(12) Patent Application Publication
(10) Pub. No.: US 2004/0163312 A1
(43) Pub. Date: Aug. 26, 2004

(54) Diesel steam reforming with CO2 fixing

(75) Inventors: David P. Bloomfield, Boston, MA (US); James F. Stevens, Katy, TX (US)

Correspondence Address: CHEVRON TEXACO, LAW DEPT. - INTELLECTUAL PROPERTY UNIT, 1111 BAGBY STREET, SUITE 4040, HOUSTON, TX, 77002, US

(73) Assignees: Texaco Inc., San Ramon, CA; TEXACO DEVELOPMENT CORPORATION, San Ramon, CA

(21) Appl. No.: 10/783,505

(22) Filed: Feb. 20, 2004

Related U.S. Application Data
(60) Provisional application No. 60/449,822, filed on Feb. 24, 2003.

(51) Int. Cl. B01J 8/00; C10J 3/20

(52) U.S. Cl. 48/214 A; 48/127.9; 48/198.1; 48/198.3; 48/198.7; 48/211; 48/212; 48/214 R; 48/75; 48/102 R; 48/94

(57) ABSTRACT

Method and apparatus for steam reforming a sulfur-containing hydrocarbon fuel, such as a diesel hydrocarbon fuel. The apparatus includes a desulphurization unit, a pre-reformer, and a steam reforming unit. A carbon dioxide fixing material is present in the steam reforming catalyst bed to fix carbon dioxide that is produced by the reforming reaction. The carbon dioxide fixing material is an alkaline earth oxide, a doped alkaline earth oxide or a mixture thereof. The fixing of carbon dioxide within the steam reforming catalyst bed creates an equilibrium shift in the steam reforming reaction to produce more hydrogen and less carbon monoxide. Carbon dioxide fixed in the catalyst bed can be released by heating the carbon dioxide fixing material or catalyst bed to a temperature in excess of the steam reforming temperature. Fuel processors having multiple catalyst beds and methods and apparatus for generating electricity utilizing such fuel processors in conjunction with a fuel cell are also disclosed.

### BACKGROUND OF THE INVENTION

Fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is generally proportional to the consumption rate of the reactants.

A significant disadvantage which inhibits the wider use of fuel cells is the lack of a widespread hydrogen infrastructure. Hydrogen has a relatively low volumetric efficiency and is more difficult to store and transport than the hydrocarbon fuels currently used in most power generation systems. One way to overcome this difficulty is the use of reformers to convert the hydrocarbons to a hydrogen-rich gas stream that can be used as a feed for fuel cells.

Fuel reforming processes, such as steam reforming, partial oxidation, and autothermal reforming, can be used to convert hydrocarbon fuels such as natural gas, LPG, gasoline, and diesel, into a hydrogen rich gas. In addition to the desired product hydrogen, undesirable byproduct compounds such as carbon dioxide and carbon monoxide are found in the product gas. For many uses, such as fuel for proton exchange membrane (PEM) or alkaline fuel cells, these contaminants reduce the value of the product gas in part due to the sensitivity of PEM fuel cells to carbon monoxide and sulfur.

In a conventional steam reforming process, a hydrocarbon feed, such as methane, natural gas, propane, gasoline, naphtha, or diesel, is vaporized, mixed with steam, and passed over a steam reforming catalyst. The majority of the feed hydrocarbon is converted to a mixture of hydrogen, carbon monoxide, and carbon dioxide. The reforming product gas is typically fed to a water-gas shift bed in which much of the carbon monoxide is reacted with steam to form carbon dioxide and hydrogen. However, water-gas shift beds tend to be large complex units that are typically sensitive to air, further complicating their startup and operation.

After the shift step, additional purification steps are needed to bring the hydrogen purity to the desired level. These steps include, but are not limited to, selective oxidation to remove remaining carbon monoxide, flow through a hydrogen permeable membrane, and pressure swing absorption. However, even selective oxidizers that are intended to clean up carbon monoxide, are often not sufficiently selective. Typically, even the most selective units will claim at least one half mole of hydrogen per mole of carbon monoxide consumed. Hydrogen that is generated by a fuel processor and that is not available to the fuel cell reduces the efficiency of the integrated unit and increases the demands on the fuel processor's capacity and costs.

For use in a PEM fuel cell, the reformate hydrogen purity that is specified can vary widely between 35% and 99.999% with very low (<50 ppm) carbon monoxide level desirable. Generally, higher hydrogen purity improves fuel cell efficiency and cost. For alkaline fuel cells, low carbon dioxide levels are needed to prevent formation of carbonate salts. For these and other applications, an improved steam reforming process capable of providing a high hydrogen, low carbon monoxide, low carbon dioxide reformate is greatly desired.

The disclosure of U.S. Ser. No. 10/126,679, filed Apr. 18, 2002, and published on Oct. 24, 2002, under Publication Number US 2002/01/55329 A1, is incorporated herein by reference.

### SUMMARY OF THE INVENTION

The present invention provides an integrated fuel processor for steam reforming a sulfur-containing hydrocarbon fuel. The integrated fuel processor comprises a desulphurization unit for reducing the sulfur content of the hydrocarbon fuel, a pre-reformer for catalytically converting the hydrocarbon fuel to a mixture of C_{1 and C}₂ hydrocarbons, and a steam reformer for reforming the mixture of C_{1 and C}₂ hydrocarbons to a reformate stream comprising hydrogen and carbon dioxide. The steam reformer has a catalyst bed that comprises a steam reforming catalyst and optionally a water gas shift catalyst. The catalyst bed further comprises a carbon dioxide fixing material for fixing carbon dioxide produced in the steam reforming reaction. The carbon dioxide fixing material fixes carbon dioxide at a steam reforming temperature that is between about 400° C. and about 800° C., but preferably above about 500° C. and more preferably above about 550° C. The carbon dioxide fixing material is preferably an alkaline earth oxide, a doped alkaline earth oxide or mixtures thereof. The carbon dioxide fixing material is capable of being regenerated by heating at a temperature above the steam reforming temperature, but preferably above 550° C. and more preferably above about 600° C. The carbon dioxide fixing material may be heated by flowing a gas stream through the material such as a stream of heated air. Preferably, the sulfur-containing hydrocarbon fuel is a diesel.

Optionally, but in a highly preferred embodiment, the steam reformer comprises at least two catalyst beds and means for diverting feed streams between the at least two catalyst beds so that one bed may be regenerated while one or more other catalyst beds continue steam reforming. The fuel processor can also comprise one or more of a vaporization unit upstream from the pre-reformer for vaporizing the hydrocarbon fuel, a condenser downstream of the steam reformer for removing water and/or heat from the reformate, and a unit downstream of the steam reformer selected from the group consisting of a methanation unit, a selective oxidizer and a water gas shift reactor for removing carbon monoxide, carbon dioxide or mixtures thereof from the reformate.

The present invention further provides an apparatus for generating electricity, the apparatus comprising a fuel processor comprising a desulphurization unit for reducing the sulfur content of a hydrocarbon fuel, a pre-reformer for catalytically converting a reduced-sulfur hydrocarbon fuel to a mixture of C_{1 and C}₂ hydrocarbons, and a steam reformer for reforming the mixture of C_{1 and C}₂ hydrocarbons at a steam reforming temperature in a catalyst bed to a reformate comprising hydrogen and carbon dioxide, said catalyst bed comprising a carbon dioxide fixing material for fixing at least a portion of the carbon dioxide in the reformate to produce a hydrogen-rich reformate, and a fuel cell configured to receive the hydrogen-rich reformate from the steam reformer, wherein the fuel cell consumes a portion of the hydrogen-rich reformate and produces electricity, an anode tail gas, and a cathode tail gas. Optionally, but in a highly preferred embodiment, the apparatus further comprises a combustor or anode tail gas oxidizer in fluid communication with the pre-reformer and/or catalyst bed for producing a heated exhaust gas. In addition, the apparatus can comprise a unit intermediate the fuel processor and fuel cell selected from the group consisting of a methanation unit, a selective oxidizer and a water gas shift reactor for removing carbon monoxide, carbon dioxide or mixtures thereof from the reformate.

In a process aspect, the present invention provides a method for steam reforming a sulfur-containing hydrocarbon fuel. The process comprises the steps of reducing the sulfur content of the sulfur-containing hydrocarbon fuel to produce a reduced-sulfur hydrocarbon fuel, catalytically converting the reduced-sulfur hydrocarbon fuel to a mixture of C_{1 and C}₂ hydrocarbons, steam reforming the mixture of C₁ and C₂ hydrocarbons at a steam reforming temperature in a catalyst bed to produce a reformate comprising hydrogen and carbon dioxide, and fixing at least a portion of the carbon dioxide in the reformate with a carbon dioxide fixing material in the catalyst bed to produce a hydrogen-rich reformate. The steam reforming temperature is between about 400° C. and about 800° C., but preferably above about 500° C. and more preferably above about 550° C. The carbon dioxide fixing material fixes carbon dioxide at the steam reforming temperature. The carbon dioxide fixing material is preferably an alkaline earth oxide, a doped alkaline earth oxide or mixtures thereof. The carbon dioxide fixing material can be regenerated by heating at a temperature above the steam reforming temperature, but preferably above 550° C. and more preferably above about 600° C. The carbon dioxide fixing material can be heated by flowing a gas stream through the material such as a stream of heated air. Preferably, the sulfur-containing hydrocarbon fuel is a diesel.

Optionally, the methods of the present invention include one or more of the steps of vaporizing the hydrocarbon fuel by mixing the hydrocarbon fuel with super heated steam, cooling the hydrogen-rich reformate, removing water from the hydrogen-rich reformate, and removing carbon monoxide, carbon dioxide or mixtures thereof from the reformate stream. Carbon monoxide, carbon dioxide and mixtures thereof, can be removed from the hydrogen-rich reformate by subjecting the hydrogen-rich reformate to one or more of a water gas shift reaction, methanation, and selective oxidation. In a highly preferred embodiment, the method of the present invention will further comprise the step of heating a first catalyst bed to a temperature above the steam reforming temperature to released fixed carbon dioxide while steam reforming the mixture of C₁ and C₂ hydrocarbons in a second catalyst bed.

In a further process aspect, the present invention provides a method of generating electricity comprising the steps of reducing the sulfur content of the sulfur-containing hydrocarbon fuel, catalytically converting the reduced-sulfur hydrocarbon fuel to a mixture of C₁ and C₂ hydrocarbons, steam reforming the mixture of C_{1 and C}₂ hydrocarbons at a steam reforming temperature in a catalyst bed to produce a reformate comprising hydrogen and carbon dioxide, fixing at least a portion of the carbon dioxide in the reformate with a carbon dioxide fixing material in the catalyst bed to produce a hydrogen-rich reformate, and feeding the hydrogen-rich reformate to an anode of a fuel cell, wherein the fuel cell consumes a portion of the hydrogen-rich reformate and produces electricity, an anode tail gas and a cathode tail gas. The method can further include the step of feeding at least a portion of the tail gases to a combustor or anode tail gas oxidizer to produce an exhaust gas for use in the steam reforming of sulfur-containing hydrocarbon fuels. Optionally, but preferably, the method further includes the step of reducing the amount of carbon monoxide and/or carbon dioxide in the hydrogen-rich reformate by subjecting the hydrogen-rich reformate to one or more of a water gas shift reaction, methanation and selective oxidation.

### BRIEF DESCRIPTION OF THE DRAWINGS

FIG. 1 shows a schematic illustration of an apparatus of the present invention.

FIG. 2 is a schematic illustration of the steam reformer/separator of the present invention illustrating a plurality of steam reforming catalyst beds.

### DETAILED DESCRIPTION OF EMBODIMENTS

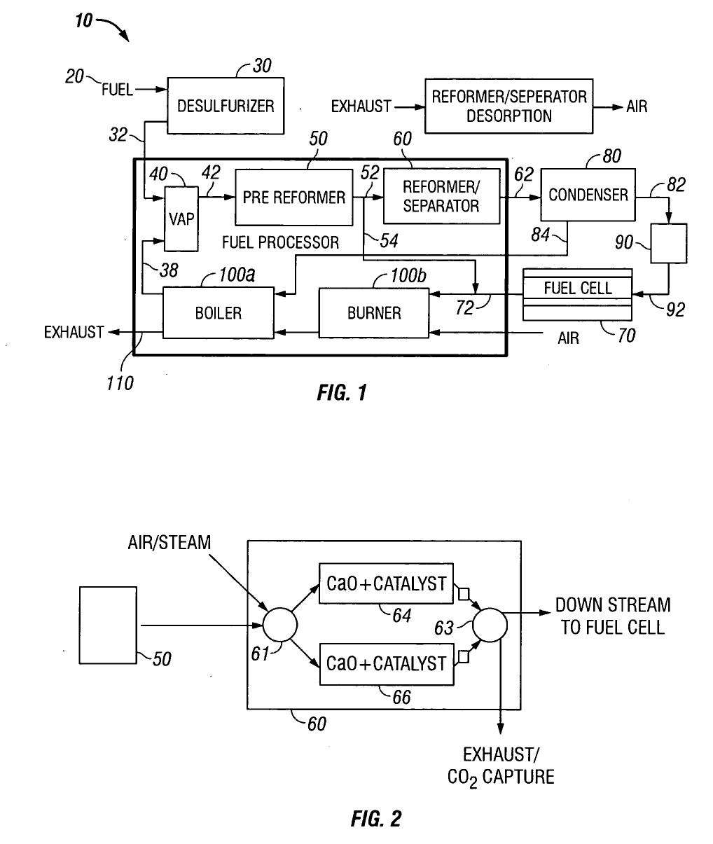

The present invention is generally directed to a method and apparatus for converting a sulfur-containing hydrocarbon fuel into a hydrogen rich gas. The sulfur-containing hydrocarbon fuel is typically diesel. The present invention simplifies the conversion process by incorporating a carbon dioxide fixing material into the initial hydrocarbon conversion process as shown in FIG. 1 and eliminating the need for water-gas shift conversion unit.

As used in this disclosure, “carbon dioxide fixing material” should be understood to refer to materials and substances that bind with carbon dioxide at a temperature in the temperature range typical of hydrocarbon conversion to hydrogen and carbon dioxide, referred to herein as a “steam reforming temperature”, including but not limited to those materials that will adsorb or absorb carbon dioxide as well as materials that will convert carbon dioxide to a different chemical species that is more easily removed from the product gas. Preferably, a carbon dioxide fixing material will comprise an alkaline earth oxide(s), a doped alkaline earth oxide(s) or mixtures thereof. Substances capable of fixing carbon dioxide in suitable temperature ranges include, but are not limited to, calcium oxide (CaO), calcium hydroxide (Ca(OH)₂), strontium oxide (SrO), strontium hydroxide (Sr(OH)₂) and mixtures thereof. In addition, suitable mineral compounds such as allanite, andralite, ankerite, anorthite, aragoniter, calcite, dolomite, clinozoisite, huntite, hydrotalcite, lawsonite, meionite, strontianite, vaterite, jutnohorite, minrecordite, benstonite, olekminskite, nyerereite, natrofairchildite, farichildite, zemkorite, butschlite, shrtite, remondite, petersenite, calcioburbankite, burbankite, khanneshite, carboncernaite, brinkite, pryrauite, strontio dressenite, similar such compounds and mixtures thereof, may be used to advantage as carbon dioxide fixing materials.

It is important to note that the reforming catalyst bed is comprised of a mixture of catalyst(s) and carbon dioxide fixing material. The carbon dioxide fixing material can be a mixture of calcium, strontium, or magnesium salts combined with binding materials such as silicates or clays that prevent the carbon dioxide fixing material from becoming entrained in the gas stream and reduce crystallization that decreases surface area and carbon dioxide absorption. Salts used to make the initial bed can be any salt, such as an oxide or hydroxide that will convert to the carbonate under process conditions. The catalyst(s) in this system serve multiple functions. One function is to catalyze the reaction of hydrocarbon with steam to give a mixture of hydrogen, carbon monoxide, and carbon dioxide. Another function is to catalyze the shift reaction between water and carbon monoxide to form hydrogen and carbon dioxide. Many chemical species can provide these functions, including rhodium, platinum, gold, palladium, rhenium, nickel, iron, cobalt, copper, and other metal based catalysts.

An important factor in this process is the recognition that the improved reformate composition is obtained by the reaction of calcium oxide with carbon dioxide to form calcium carbonate. Testing has shown that the carbon dioxide fixing material can be regenerated by heating the carbon dioxide fixing material to a higher temperature and allowing the CaCO₃ or SrCO₃ to release carbon dioxide and be reconverted to the original carbon dioxide fixing material. Heating of the carbon dioxide fixing material may be accomplished by a number of differing means known to one of skill in the art. In one such illustrative example the heating is accomplished by electrically resistant heating coils. Alternatively, a heat exchanger may be incorporated into the design of the reactor such that steam, exhaust or other heat source such as heat pipes heat the reactor. Another alternative is to heat the carbon dioxide fixing material by flowing gas through the bed under conditions in which the calcium carbonate or strontium carbonate is decomposed and the carbon dioxide is removed. This has been done in our labs using helium, nitrogen, and steam. It could also be done using the anode tail gas of a fuel cell or the tail gas of a metal hydride storage system.

It is envisioned that the system will have two or more steam reforming beds such that one or more beds may be generating reformate while the remaining beds are being regenerated. An integrated system in which tail gas from the fuel cell and/or hydrogen storage system is used to provide heat needed to reform the feed fuel and regenerate the calcium oxide bed.

FIG. 1 is a schematic representation of an apparatus of the present invention. A diesel hydrocarbon fuel stream 20 is directed to a desulphurization unit 30 where the sulfur content of the fuel stream is reduced and preferably eliminated. Preferably, desulphurization unit 30 comprises molecular sieves containing zeolites or other sulfur sorbents. Alternatively, other desulphurization materials and techniques known to those skilled in the art may be used to reduce the sulfur content of the diesel hydrocarbon fuel.

The desulfurized diesel is then passed via line 32 to vaporizer 40. Within vaporizer 40, the desulfurized diesel fuel is mixed with super heated steam. Other mechanisms and means known to those skilled in the art may be used to vaporize or atomize the diesel fuel and saturate it with water or steam for used in the pre-reformer. Further, while it has been described that the liquid diesel hydrocarbon fuel is first desulfurized and then vaporized, it will be recognized by those skilled in the art that these processes may be reversed so that the desulphurization step is performed on a vaporized diesel hydrocarbon fuel and that processes for removing sulfur from a gas stream may also be used to advantage.

Once the desulfurized diesel hydrocarbon is in the vapor phase, it is routed via line 42 to pre-reformer 50 for conversion into shorter chain length hydrocarbons. Pre-reformer 50 catalytically converts the diesel hydrocarbon primarily into methane, with trace amounts of ethane, carbon monoxide, carbon dioxide, hydrogen and potentially other contaminants. If there is residual sulfur in the fuel stream, the sulfur compounds will pass through pre-reformer 50 and be fixed in the carbon dioxide fixing materials in the catalyst beds of steam reformer 60. The diesel hydrocarbon fuel is converted within pre-reformer 50 into shorter chain length hydrocarbons using catalysts known in the art, e.g. nickel based catalyst. Selecting a catalyst for this purpose is within the abilities of one skilled in the art. To carry out the conversion reaction, pre-reformer 50 requires a vaporized diesel fuel, a steam source and a heater. As illustrated in FIG. 1, all three of these elements are provided directly through vaporizer 40.

The methane produced within pre-reformer 50 is directed via line 52 to a steam reformer 60. Within steam reformer 60 is at least one catalyst bed. As illustrated in FIG. 2, steam reformer 60 will preferably have plurality of catalyst beds 64 and 66 with flow control elements 61 and 63. Reforming catalyst beds 64 and 66 are comprised of a mixture of catalyst(s) and carbon dioxide fixing materials. Reforming catalysts are typically nickel, platinum, rhodium, palladium, and/or ruthenium metals deposited on a high surface area support such as alumina, titania, or zirconia with other materials added as promoters or stabilizers. It is important that the catalyst be stable at the temperatures needed for regenerating the carbon dioxide fixing material. Preferably, the steam reforming catalyst is a precious metal catalyst such as platinum, palladium, rhodium and/or ruthenium on an alumina washcoat on a monolith, extrudate, pellet or other support. Optionally, catalyst beds 64 and 66 may also comprise a water gas shift catalyst. When utilized, the water gas shift catalyst selected should be a high temperature shift catalyst as are known in the art so that their activity is not degraded during the regeneration of the carbon dioxide fixing materials. Examples of high temperature shift catalysts include transition metal oxides and supported noble metals such as supported platinum, palladium and ort other platinum group members.

Upon contacting the active catalyst bed the methane is converted to hydrogen, carbon monoxide and carbon dioxide. The carbon dioxide fixing material removes the carbon dioxide from the stream and shifts the reaction equilibrium toward high hydrocarbon conversion with only small amounts of carbon monoxide being produced. The low level of carbon monoxide production allows the elimination of water-gas shift catalysts units currently used in most fuel processors. As noted above, and where additional reductions in carbon monoxide are desired, water gas shift catalyst can be included in the catalyst bed or a separate shift reactor may be utilized downstream.

The reformate from the catalyst bed is cooled by optionally present heat exchangers or a condenser (80) and then flows to a polishing unit 90 that removes carbon monoxide and carbon dioxide. Condenser 80 preferably is configured with line 84 for recycling condensed water to boiler 100a where super heated steam is generated. The low levels of carbon monoxide are reduced to trace levels<10 ppm through selective oxidation or methanation. It is expected that the removal of carbon dioxide will make methanation the desired process, although selective oxidation is also envisioned by the present invention. Methanation or selective oxidation is referenced in FIG. 1 at reference number 90.

The purified reformate stream (hydrogen-rich reformate) is optionally cooled and then flows to the anode of fuel cell. The fuel cell typically uses 70 to 80% of the hydrogen to produce electricity while the methane flows through the anode unchanged. Alternatively, the hydrogen rich gas can be stored in a metal hydride storage system (not shown), for later use as feed to fuel cell.

Still with reference to FIG. 1, the anode tail gas is then combined with the cathode tail gas (72), and is combusted in an anode tail gas oxidizer or combustor (100b). Combustor 100b is connected to pre-reformer 50 via conduit 54. A portion of the methane produced by pre-reformer 50 is directed to combustor 100b to aid in the combustion of tail gases form the fuel cell stack. A source of air is also provided to facilitate this combustion. Exhaust from combustor 100b is then passed through a heat exchanger or boiler 100a and to an exhaust. Water is heated in boiler 100a and is used as steam feed for a portion of the fuel reforming process i.e. vaporization, and may be directed to reformer 60 to regenerate the catalyst beds. Once the carbon dioxide fixing material is regenerated the heated process water is diverted away from the regenerated bed. Combustor 100b and boiler 100a are illustrated in FIG. 1, as separate and distinct features of the fuel processor, however, those skilled in the art will recognize that such elements are commonly integrated into a single unit or module.

Catalyst beds 64 and 66 are preferably regenerated by heating them to a temperature above the steam reforming temperature. As noted elsewhere herein, steam reforming may be carried out at temperatures between about 400° C. and about 800° C. and preferably above 500° C. and more preferably above 550° C. Regenerating the carbon dioxide fixing material will occur at a temperature above the steam reforming temperature, typically above 550°, preferably above about 600° C., more preferably above about 700° C., still more preferably above about 750° C., and yet still more preferably above about 800° C. In addition, it has been found that the time required to regenerate a given bed of carbon dioxide fixing material may be reduced by regenerating the material at a higher temperature.

Heating of catalyst beds 64 and 66 may be accomplished by a number of different means known to one of skill in the art. In one such illustrative example, the heating is accomplished by electrically resistant heating coils. Alternatively, a heat exchanger may be incorporated into the design of the reactor such that steam, exhaust or other heat sources such as heat pipes can be used heat the reactor. Another alternative is to heat the carbon dioxide fixing material by flowing a gas through the bed under conditions in which carbon dioxide is released. More specifically, where the carbon dioxide has been converted in the bed to a different chemical species, regeneration can be achieved by flowing heated gas through the bed so that calcium carbonate or strontium carbonate is decomposed and the carbon dioxide is released and removed. This has been achieved using gas flows of helium, nitrogen, and steam. It is envisioned that it could also be done using the anode tail gas of a fuel cell, the tail gas of a metal hydride storage system and heated air. Once the regenerated bed cools to the desired steam reforming temperature, the catalyst beds can be switched and another bed can be regenerated. When heated gas is flowed through the bed to regenerate it, the tail gas from the regeneration flows through valving and out of the exhaust header. Alternatively, the anode tail gas and the cathode tail gas of the fuel cell may be directly passed through heat exchanger and to an exhaust.

Although FIG. 2 shows two reforming catalyst beds, it is intended by the present invention that more than two reforming catalyst beds may be utilized. For example, three reforming catalyst beds can be utilized in the following manner: one bed in operation, one bed in regeneration, and one bed cooling down from regeneration temperature to process temperature.

A skilled person in the art should also appreciate that the present invention also encompasses the following illustrative embodiments. One such illustrative embodiment includes a method for converting a sulfur-containing hydrocarbon fuel such as diesel, to a hydrogen-rich reformate, comprising the steps of reducing the sulfur content of the sulfur-containing hydrocarbon fuel to produce a reduced-sulfur hydrocarbon fuel, catalytically converting the reduced-sulfur hydrocarbon fuel to a mixture of C₁ and C₂ hydrocarbons, steam reforming the mixture of C₁ and C₂ hydrocarbons at a steam reforming temperature in a catalyst bed to produce a reformate comprising hydrogen and carbon dioxide, and fixing at least a portion of the carbon dioxide in the reformate with a carbon dioxide fixing material in the catalyst bed to produce a hydrogen-rich reformate. The carbon dioxide fixing material fixes carbon dioxide at the steam reforming temperature. A preferred aspect of the present embodiment is a steam reforming temperature in the range from about 400° C. to about 800° C., but preferably above about 500° C. and more preferably above about 550° C. Preferably, the carbon dioxide fixing material is selected from a calcium oxide, calcium hydroxide, strontium oxide, strontium hydroxide, or any combination thereof. The carbon dioxide fixing material can be regenerated by heating at a temperature above the steam reforming temperature, but preferably above 550° C. and more preferably above about 600° C. The reforming catalyst can be any reforming catalyst known to those of skill in the art, such as nickel, platinum, rhodium, palladium, ruthenium, or any combination thereof. Furthermore, the reforming catalyst can be supported on any high surface area support known to those of skill in the art, such as alumina, titania, zirconia, or any combination thereof. It is expected that the present embodiment can easily achieve a hydrogen rich gas having a carbon monoxide concentration less than about 10 wppm.

Another illustrative embodiment of the present invention is a method for operating a fuel cell, comprising the steps of reducing the sulfur content of the sulfur-containing hydrocarbon fuel, catalytically converting the reduced-sulfur hydrocarbon fuel to a mixture of C_{1 and C}₂ hydrocarbons, steam reforming the mixture of C₁ and C₂ hydrocarbons at a steam reforming temperature in a catalyst bed to produce a reformate comprising hydrogen and carbon dioxide, fixing at least a portion of the carbon dioxide in the reformate with a carbon dioxide fixing material in the catalyst bed to produce a hydrogen-rich reformate, and feeding the hydrogen-rich reformate to an anode of a fuel cell, wherein the fuel cell consumes a portion of the hydrogen-rich reformate and produces electricity, an anode tail gas and a cathode tail gas. The carbon dioxide fixing material fixes carbon dioxide at the steam reforming temperature. A preferred aspect of the present embodiment is a steam reforming temperature in the range from about 400° C. to about 800° C., but preferably above about 500° C. and more preferably above about 550° C. Preferably, the carbon dioxide fixing material is selected from a calcium oxide, calcium hydroxide, strontium oxide, strontium hydroxide, or any combination thereof. The carbon dioxide fixing material can be regenerated by heating at a temperature above the steam reforming temperature, but preferably above 550° C. and more preferably above about 600° C. The reforming catalyst can be any reforming catalyst known to those of skill in the art, such as nickel, platinum, rhodium, palladium, ruthenium, or any combination thereof. Furthermore, the reforming catalyst can be supported on any high surface area support known to those of skill in the art, such as alumina, titania, zirconia, or any combination thereof. The anode tail gas and the cathode tail gas may then be fed to an anode tail gas oxidizer or a combustor to produce an exhaust gas, such that exhaust gas is usable to regenerate the carbon dioxide fixing material. Alternatively, the anode tail gas and the cathode tail gas may be used to directly preheat process water, such that the heated process water is usable to regenerate the carbon dioxide fixing material. Optionally, but preferably, the method further includes the step of reducing the amount of carbon monoxide and/or carbon dioxide in the hydrogen-rich reformate by subjecting the hydrogen-rich reformate to one or more of a water gas shift reaction, methanation and selective oxidation. It is expected that the present embodiment can easily achieve a hydrogen rich gas having a carbon monoxide concentration less than about 10 wppm.

Yet another illustrative embodiment of the present invention is an apparatus for producing electricity from a sulfur-containing hydrocarbon fuel such as a diesel hydrocarbon fuel, the apparatus comprising at least two catalyst beds, wherein each catalyst bed comprises reforming catalyst and carbon dioxide fixing material. The apparatus comprises a first manifold capable of diverting a feed stream between the at least two reforming catalyst beds, and a second manifold capable of diverting the effluent of each catalyst bed effluent between the reactor and exhaust. The apparatus can include a reactor, such as a methanation reactor or selective oxidation reactor, capable of reducing the carbon monoxide concentration of the effluent of at least one of the catalyst beds. A fuel cell is also envisioned operably connected to the apparatus for producing electricity and converting the hydrogen-rich reformate to anode tail gas and cathode tail gas. Alternatively, the hydrogen rich gas can be stored in a metal hydride storage system as a source for later feed to a fuel cell. A preferred aspect of the present embodiment is an anode tail gas oxidizer that combusts the anode tail gas and cathode tail gas to produce an exhaust gas. A third manifold can then be utilized to divert the exhaust gas to each catalyst bed for regeneration. Alternatively, a water preheater can be employed to heat process water using the anode tail gas and the cathode tail gas. The first manifold is then capable of diverting the preheated water to at least one of the reforming catalyst beds for regeneration. Alternatively, a water preheater can be employed to heat process water using the exhaust gas from the anode tail gas oxidizer. The first manifold is then capable of diverting the preheated water to at least one of the catalyst beds for regeneration.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention.

What is claimed is:

1. A fuel processor for steam reforming a sulfur-containing hydrocarbon fuel, the processor comprising:
a desulphurization unit for reducing the sulfur content of a hydrocarbon fuel;
a pre-reformer for catalytically converting a reduced-sulfur hydrocarbon fuel to a mixture of C_{1 and C}₂ hydrocarbons; and
a steam reformer for reforming the mixture of C_{1 and C}₂ hydrocarbons at a steam reforming temperature to a reformate comprising hydrogen and carbon dioxide, said catalyst bed comprising a carbon dioxide fixing material for fixing at least a portion of the carbon dioxide in the reformate.

2. The fuel processor of claim 1, wherein the hydrocarbon fuel is a diesel.

3. The fuel processor of claim 1, further comprising a vaporization unit upstream of the pre-reformer for vaporizing the hydrocarbon fuel.

4. The fuel processor of claim 1, further comprising a condenser downstream of the steam reformer for removing water from the reformate.

5. The fuel processor of claim 1, further comprising a unit downstream of the steam reformer selected from the group consisting of a methanation unit, selective oxidizer, and water gas shift reactor, for removing carbon monoxide, carbon dioxide or mixtures thereof, from the reformate.

6. The fuel processor of claim 1, wherein the catalyst bed comprises a steam reforming catalyst, said steam reforming catalyst comprises a precious metal catalyst.

7. The fuel processor of claim 1, wherein the catalyst bed comprises a water gas shift catalyst.

8. The fuel processor of claim 1, wherein the carbon dioxide fixing material is selected from an alkaline earth oxide, doped alkaline earth oxide and mixtures thereof.

9. The fuel processor of claim 1, wherein the pre-reformer comprises a catalyst suitable for converting the hydrocarbon fuel to a mixture of C_{1 and C}₂ hydrocarbons.

10. The fuel processor of claim 1, wherein the steam reformer comprises at least two catalyst beds and means for diverting feed streams between the at least two catalysts beds.

11. A method for steam reforming a sulfur-containing hydrocarbon fuel, the method comprising the steps of:
reducing the sulfur content of a sulfur-containing hydrocarbon fuel to a reduced-sulfur hydrocarbon fuel;
catalytically converting the reduced-sulfur hydrocarbon fuel to a mixture of C_{1 and C}₂ hydrocarbons;
steam reforming the mixture of C_{1 and C}₂ hydrocarbons at a steam reforming temperature in a catalyst bed to produce a reformate comprising hydrogen and carbon dioxide; and
fixing at least a portion of the carbon dioxide in the reformate with a carbon dioxide fixing material in the catalyst bed to produce a hydrogen-rich reformate.

12. The method of claim 11, wherein the sulfur-containing hydrocarbon fuel is a diesel.

13. The method of claim 11, further comprising the step of vaporizing a hydrocarbon fuel by mixing the hydrocarbon fuel with super heated steam.

14. The method of claim 11, further comprising the step of cooling the hydrogen-rich reformate.

15. The method of claim 11, further comprising the step of removing water from the hydrogen-rich reformate.

16. The method of claim 11, further comprising the step of removing carbon monoxide, carbon dioxide or mixtures thereof from the hydrogen-rich reformate.

17. The method of claim 16, wherein the amount of carbon monoxide and/or carbon dioxide in the hydrogen-rich reformate is reduced by subjecting the hydrogen-rich reformate to one or more of a water gas shift reaction, methanation, and selective oxidation.

18. The method of claim 11, wherein the carbon dioxide fixing material is an alkaline earth oxide, a doped alkaline earth oxide or a mixture thereof.

19. The method of claim 11, further comprising the step of heating the carbon dioxide fixing material to a temperature above the steam reforming temperature to release fixed carbon dioxide.

20. The method of claim 19, wherein the carbon dioxide fixing material is heated to a temperature above 550° C.

21. The method of claim 11, further comprising the step of heating a first catalyst bed to a temperature above the steam reforming temperature to release fixed carbon dioxide while steam reforming the mixture of C_{1 and C}₂ hydrocarbons in a second catalyst bed.

22. An apparatus for generating electricity, the apparatus comprising:
a fuel processor comprising a desulphurization unit for reducing the sulfur content of a hydrocarbon fuel, a pre-reformer for catalytically converting a reduced-sulfur hydrocarbon fuel to a mixture of C₁ and C₂ hydrocarbons, and a steam reformer for reforming the mixture of C₁ and C₂ hydrocarbons at a steam reforming temperature in a catalyst bed to a reformate comprising hydrogen and carbon dioxide, said catalyst bed comprising a carbon dioxide fixing material for fixing at least a portion of the carbon dioxide in the reformate to produce a hydrogen-rich reformate; and
a fuel cell configured to receive the hydrogen-rich reformate from the fuel processor and wherein the fuel cell consumes a portion of the hydrogen-rich reformate and produces electricity, an anode tail gas, and a cathode tail gas.

23. The apparatus of claim 22, further comprising a combustor in fluid communication with the pre-reformer and/or catalyst bed for producing a heated exhaust gas.

24. A method for generating electricity, the method comprising the steps of:
reducing the sulfur content of a hydrocarbon fuel;
converting a reduced-sulfur hydrocarbon fuel to a mixture of C₁ and C₂ hydrocarbons;
steam reforming the mixture of C₁ and C₂ hydrocarbons at a steam reforming temperature in a catalyst bed to produce a reformate comprising hydrogen and carbon dioxide; and
fixing at least a portion of the carbon dioxide in the reformate with a carbon dioxide fixing material in the catalyst bed to produce a hydrogen-rich reformate; and
feeding the hydrogen-rich reformate to an anode of a fuel cell, wherein the fuel cell consumes a portion of the hydrogen-rich reformate and produces electricity, an anode tail gas, and a cathode tail gas.

25. The method of claim 24, further comprising the step of feeding the anode tail gas and/or the cathode tail gas to an anode tail gas oxidizer to produce an exhaust gas.

26. The method of claim 24, further comprising the step of heating the carbon dioxide fixing material to a temperature above the steam reforming temperature to release fixed carbon dioxide.

27. The method of claim 25, further comprising the step of reducing the amount of carbon monoxide and/or carbon dioxide in the hydrogen-rich reformate by subjecting the hydrogen-rich reformate to one or more of a water gas shift reaction, methanation, and selective oxidation.
